(19) United States
(12) Patent Application Publication
(10) Pub. No.: US 2020/0226278 A1
(43) Pub. Date: Jul. 16, 2020

(54) Secure document messaging system, device, and method using biometric authentication

(71) Applicant: PECX Inc., Porter Ranch, CA (US)

(72) Inventor: Lisa Goshon, Porter Ranch, CA (US)

(21) Appl. No.: 16/744,055

(22) Filed: Jan. 15, 2020

Related U.S. Application Data
(60) Provisional application No. 62/918,179, filed on Jan. 16, 2019.

(51) Int. Cl. G06F 21/62; H04L 29/06; G06F 16/93

(52) U.S. Cl. CPC G06F 21/6218; G06F 16/93; H04L 63/0861

(57) ABSTRACT

A secure document messaging system, includes a secure document messaging server, including a message store; and a secure document messaging device that enables a sending user to create a message object, including message information, recipients, a biometric authentication flag, attachments, and expiration time; such that the sending user is required to perform a biometric authentication in order to lock the message object, and a receiving user is required to perform a biometric authentication to access the message object. The secure document messaging device can communicate with a biometric authentication server in order to perform biometric authentication processing. Also disclosed is a method for secure document messaging, including creating a message, storing the message, sending the message, receiving the message, and accessing the message.

### CROSS-REFERENCE TO RELATED APPLICATIONS

This application claims the benefit of U.S. Provisional Application No. 62/918,179, filed Jan. 16, 2019; which is hereby incorporated herein by reference in its entirety.

### FIELD OF THE INVENTION

The present invention relates generally to the field of document management and messaging, and more particularly to methods and systems for securing digital content with biometric authentication.

### BACKGROUND OF THE INVENTION

Of the almost eight billion people on planet earth, nearly 33% (approx. 2.4 billion) own some type of mobile device or personal digital assistant (PDA). Nearly half use the device to send and receive files containing digital content (photo, video or text) either directly to an individual or post on a social media platform like Facebook, Twitter, Instagram, etc.

With so much data being transmitted, clearly a major concern with sharing digital content using a mobile device is security. Hacking, privacy breaches and data contamination have become as commonplace as making a phone call. Unfortunately, as technology evolves so do hackers.

Biometric authentication is the highest form of data security used today to protect sensitive and proprietary data. Turning the biometric authentication function on or off in any biometric access control system is normally controlled at the systems administrator level.

Currently, biometric authentication access management is “only” used to access (or unlock) a smartphone, a computing device such as a computer, tablet, kiosk, or an application or web page in the transaction of processing financial information such as biometric payment cards, point-of-sale and payment systems, mobile wallet applications and cash transfer systems.

In addition, current biometric authentication access management systems are controlled at the network or application level and not by the user. Therefore, users do not have the ability to “grant” or “deny” others access to their data using biometric sensing technologies such as face recognition, iris, Touch ID, voice recognition, etc.

As such, considering the foregoing, it may be appreciated that there continues to be a need for novel and improved devices and methods for securing digital content with biometric authentication.

### SUMMARY OF THE INVENTION

The foregoing needs are met, to a great extent, by the present invention, wherein in aspects of this invention, enhancements are provided to the existing model for securing digital content with biometric authentication.

In an aspect, a secure document messaging system can include:
a) a secure document messaging server, which can include:
   a message store; and
b) a secure document messaging device, which can include:
   a lock dialogue;
wherein the secure document messaging device is configured to enable a sending user to create a message object, which can include:
   message information;
   one or more recipients; and
   a biometric authentication flag;
wherein the lock dialogue enables the sending user to lock the message object, such that the sending user is required to perform a sender biometric authentication;
such that if the sender biometric authentication succeeds, the biometric authentication flag is set to true, such that the message object is locked; and such that if the sender biometric authentication fails, the biometric authentication flag is set to false;
such that the secure document messaging device stores the message object in the message store of the secure document messaging server;
wherein the secure document messaging device enables the sending user to send the message object to the recipients, if the biometric authentication flag is set to true.

In a related aspect, the secure document messaging device can further include:
a) a processor;
b) a non-transitory memory;
c) an input/output component; and
d) a messaging controller, which is configured to enable a receiving user to receive the message object;
wherein the messaging controller enabled a receiving user to access the message object, such that the receiving user opens the message object;
wherein if the biometric authentication flag is set to true, the receiving user is required to perform a biometric authentication prior to accessing the message object, such that if the biometric authentication fails, the message object cannot be opened.

In another related aspect, the secure document messaging server can further include:
a) a processor;
b) a non-transitory memory;
c) an input/output component; and
d) an authenticated user registry, which comprises at least one biometrically authenticated user;

wherein the secure document messaging device is configured to enable the sending user to select at least one recipient from the authenticated user registry, in communication via the secure document messaging server.

In a further related aspect, the message object can further include:
at least one attachment file; and
an expiration time, which indicates when the message object expires.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a secure document messaging system, according to an embodiment of the invention.

FIG. 2 is a schematic diagram illustrating a secure document messaging server, according to an embodiment of the invention.

FIG. 3 is a schematic diagram illustrating a secure document messaging device, according to an embodiment of the invention.

FIG. 4 is a flowchart illustrating steps that may be followed, in accordance with one embodiment of a method or process of secure document messaging.

FIG. 5 is a schematic diagram illustrating a date structure for a message object, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

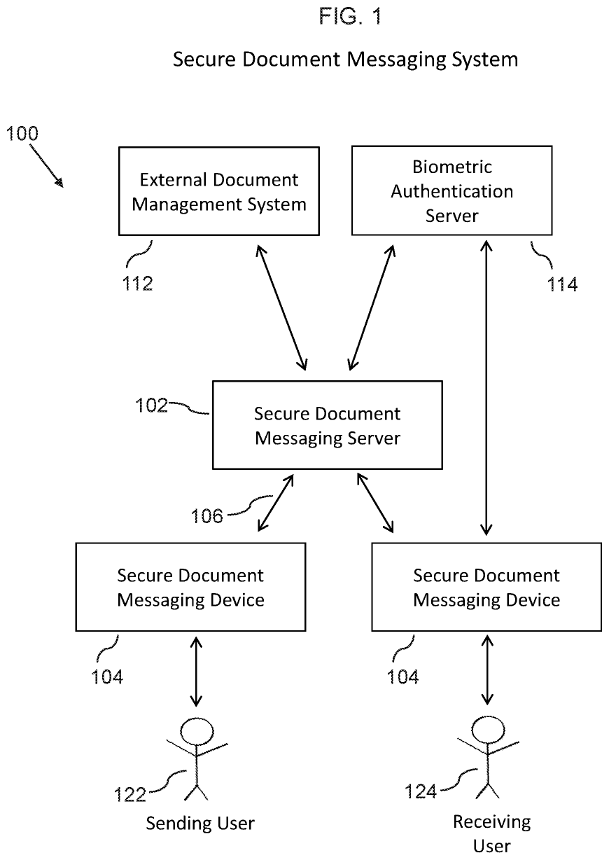

In the following, we describe the structure of an embodiment of a secure document messaging system 100 with reference to FIG. 1, in such manner that like reference numerals refer to like components throughout; a convention that we shall employ for the remainder of this specification.

In related embodiments, unlike conventional biometric access control systems, the secure document messaging system 100 gives users the option to turn the biometric authentication function on/off before a file is transferred and accessed.

In further related embodiments, for example, when a user 122 sends a file using a mobile device/PDA 104 the user has the option to turn on the biometrics function. The sender also has the option to set the time the message will expire using the proprietary Expiration Clock (Automatic, 8 hours, 24 hours, 48 hours, 72 hours, etc.).

In other related embodiments, when recipients 124 receive the file (and attachment) they must first authenticate their identity using one or more biometric sensing technologies (face recognition, touch ID, voice recognition) or other type(s) of biometric element. Once the recipient's identity is authenticated, the file will automatically display.

In related embodiments, the secure document messaging system 100 provides a system and method for invoking biometric sensing technologies (face recognition, touch ID, voice recognition) when transferring and accessing secured files containing digital content (photos, videos, text) via a mobile application on a mobile device or personal digital assistant using a software agent.

The secure document messaging system 100 can also be referred to as a Private Encrypted Content Exchange 100, which can be abbreviated as PECX 100. It is a biometric authentication access management system and method used to secure digital information (emails, text messages, instant messages) using biometric sensing technologies, including face, iris, voice, or fingerprint authentication. Digital content is transferred via communication or messaging protocols, i.e., SMS, XMPP, SMTP, FTTP, etc.

The secure document messaging system 100 advances how end-users manage and use biometric sensing technologies (face, voice, iris or fingerprints) when transferring digital content using either a smartphone or other computing device.

In various related embodiments, the secure document messaging system 100, which can also be referred to as the PECX biometric authentication access management (BAAM) system 100, can be controlled by the end-user and can be turned on or off whenever data is being transferred or shared using a smartphone or other computing device. This in turn forces the recipients to “authenticate” or confirm their identity to view the data using one of the biometric sensing technologies.

In a related embodiment, the secure document messaging system 100 is also used to enhance security as well as reduce the risk of hacking, data breaches, phishing, key logging, password copying, etc.

In another related embodiment, the secure document messaging system 100 gives users total control of who has access to their content using the biometric authentication system, the method used to access the content (facial, voice, touch ID), and how long the content is available for viewing (Automatic, 8 hours, 24 hours, 48 hours, 72 hours, etc.).

In yet a related embodiment, the secure document messaging system 100 can provide a mobile application executing on a mobile device, that provides a system and method that invokes biometric sensing technologies (face recognition, touch ID, voice) when transferring and accessing secured files containing digital content (photos, videos, text) via a mobile application on a mobile device or PDA.

In yet a related embodiment, the secure document messaging system 100 can use a proprietary on-screen lock 314 to turn on biometric authentication. The secure document messaging system 100 also has a proprietary Expiration Clock such that users can set the time when a message should expire.

In a related embodiment, once a message is received, the recipient is required to authenticate using one or more biometric sensing technologies (facial recognition, touch ID, voice). The systems and methods use a separate and secure network to encrypt, decrypt and store the digital content. The digital content can be stored either on the user's mobile device, PDA (personal digital assistant) or in some cloud storage, such as ICLOUD™.

In related embodiments, the type of individual or business that would use the secure document messaging system 100 can be anyone concerned with privacy, controlling who and how their data is accessed, and protecting what is shared over a public or private network.

In related embodiments, the secure document messaging system 100 can be used by businesses that handle very “sensitive” private data such as financial institutes, the healthcare and entertainment industry.

Thus, in various related embodiments, the secure document messaging system 100 can provide privacy, security, efficiency and cost reduction. Privacy is the number one concern for consumers when it comes to digital content and sharing. Consumers are also cost conscience so having the ability to set data to automatically expire without having to manually delete the information, or pay for more storage, is huge. The secure document messaging system 100 allows users to have control, and say, over who has access to their data, the method used to access the data, and controlling when and how the data is deleted. Additionally, enterprise users can reduce cost on password resets and other help desk costs incurred with help desk support.

In an embodiment, a process flow of the secure document messaging system 100 can include:
a) Sign Up:
   i. Download app;
   ii. Confirm iCloud or Google Suite; and
   iii. Confirm Biometric Registration; Go to Home Page;
b) Login:
   i. Open App;
   ii. Authenticate Login; and
   iii. Go to Home Page;
c) Home Page:
   i. Provides icons to access functionality;
d) Create Message:
   i. Tap icon; Add subject; Type message; Set Expiration; Select contacts; Attach digital content; Lock file; Send;
e) Read Message:
   i. Select message to view; Authenticate; View message;
f) Reply to Message:
   i. Type message; Attach digital content; Set Expiration; Send;
g) View Sent Messages:
   i. Tap icon; View Messages;
h) Alerts:
   i. Tap icon; View Alerts;
   ii. Search Page.

In a related embodiment, a more detailed process flow for using the secure document messaging system 100 can include:
a) First, the user downloads the application, for example from the APPLE STORE™ or GOOGLE PLAY™;
b) After the installation is complete, the user opens the app;
c) The “Welcome” screen appears;
d) The user taps the “Next” button;
e) The “Confirm Credentials” window appears. The user is required to confirm their credentials before proceeding, for example via:
   i. APPLE™ confirmation via iCloud; or
   ii. GOOGLE™ confirmation via GOOGLE SUITE™;
f) Next the Authentication window appears;
g) The User 122 authenticates their identity via biometrics, i.e., facial recognition, touch ID, voice (Note: the process of biometric authentication is determined specifically by the type of device 104 the user is using);
h) The Home Page appears. The user 122 can take a number of actions, including:
   i. Create a Message;
   ii. Read Message;
   iii. View Sent Message;
   iv. View Alerts;
   v. Search;
i) To Create a Message, the user can tap on the icon, and:
   i. The user types a Heading in the Subject Field;
   ii. The user types a Message in the Message field;
   iii. The user sets the Expiration Clock (Automatic, 8 hours, 24 hours, 48 hours, 72 hours, etc.);
   iv. The user selects Recipients from the Contacts List;
   v. The user Attaches the digital content (photo, audio/video file document) from:
      1. Phone's 100 Gallery;
      2. An external device (for example ICLOUD™ based), external server, or external document management system 112;
      3. Record video with mobile device or PDA; and/or
      4. Take photo with the mobile device or PDA;
   vi. The user taps “Next”;
   vii. The proprietary on-screen lock displays. User can turn the biometrics feature off NOTE: the default is set to “On”;
   viii. The user hits Send;
   ix. A “message sent” confirmation is shown;
   x. The app returns to the Home Page;
j) To Read Messages, user taps on icon, such that:
   i. All Unread Messages appear;
   ii. User touches the message to view;
   iii. The user authenticates access by performing a biometric authentication;
   iv. The unread message appears. The user can reply to the message by tapping the “Reply” button;
k) To Reply to a Message, user taps the Reply icon, such that:
   i. The Message field appears;
   ii. The user types the reply;
   iii. The user sets the Expiration clock (Automatic, 8 hours, 24 hrs, 48 hrs, 72 hrs, etc.);
   iv. The user Attaches the digital content (photo, video) from:
      1. Phone's 100 Gallery;
      2. An external device (for example ICLOUD™ based), external server, or external document management system 112;
      3. Record video with mobile device or PDA; and/or
      4. Take photo with the mobile device or PDA;
   v. The user taps “Next”;
   vi. The proprietary on-screen lock displays. The user 122 can turn the biometrics feature off. NOTE: the default is set to “On”;
   vii. The user hits Send; and
   viii. The app returns to the Home Page;
l) To View Sent Messages, user taps the icon, such that:
   i. All Sent Messages appear;
   ii. User selects the Sent message to view; and
   iii. The Sent message appears;
m) To View Alerts, user taps the icon, such that:
   i. Alerts appear; and
   ii. Alerts are listed in chronological order from oldest to newest;
n) To Search, user taps the icon, such that:
   i. User types in key words in the Search field; and
   ii. All content referring to the keyword(s) appear and the user can select which message to view.

Thus, in various embodiments, the secure document messaging system 100 provides a number of highly useful and unique functions, including:
a) The sender has the ability to turn on or turn off the biometric access control system. Other biometric systems are controlled at the systems administrator level which means the senders doesn't control if or when the recipient is required to authenticate;
b) An Expiration Clock, which lets the user determine when they want the message to expire. The clock intervals are measured in hours ranging from 24 hours through 720 hours (one month) to one year, or longer (Automatic, 8 hours, 24 hours, 48 hours, 72 hours, etc.); and
c) Alerts, which are messages that are nearing the expiration time and are listed in order from oldest to newest.

In example embodiments, secure document messaging devices 104 of the secure document messaging system 100 can be built on mobile platforms, such as APPLE IOS™ and ANDROID™, computers, tablets, smart TVs and other PDAs, which can be programmed using applicable/corresponding software programming languages.

Thus, in an embodiment, as shown in FIGS. 1, 2, 3, and 5, a secure document messaging system 100, can include:
a) a secure document messaging server 102, which can include:
   a message store 214, which includes a plurality of message objects 502; and
b) a secure document messaging device 104, which can include:
   a lock dialogue 314;
wherein the secure document messaging device 104 is configured to enable a sending user 122 to create a message object 502, wherein the message object 502 can include:
   message information 510;
   at least one recipient 522; and
   a biometric authentication flag 550, which can also be referred to as a biometric authentication status 550, or biometric authentication indicator 550;
wherein the lock dialogue 314 of the secure document messaging device 104 is configured to enable the sending user 122 to lock the message object 502, such that the sending user 122 is required to perform a sender biometric authentication 309 (i.e. a biometric authentication 309 of the sending user 122);
such that if the sender biometric authentication 309 succeeds, the biometric authentication flag 550 is set to true, such that the message object 502 is locked; and such that if the sender biometric authentication 309 fails, the biometric authentication flag 550 is set to false;
such that the secure document messaging device 104 stores (and is configured to store) the message object 502 in the message store of the secure document messaging server 102;
wherein the secure document messaging device 104 is configured to enable the sending user 122 to send the message object 502 to the at least one recipient 522, if the biometric authentication flag 550 is set to true.

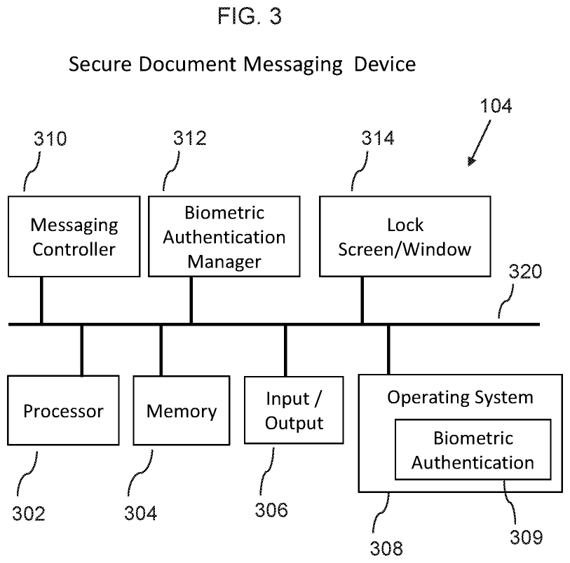

in a related embodiment, as shown in FIG. 3, the secure document messaging device 104 can further include:
a) a processor 302;
b) a non-transitory memory 304;
c) an input/output component 306; and
d) a messaging controller 310, which is configured to enable a receiving user to receive the message object; all connected via
e) a data bus 320;
wherein the messaging controller 310 is configured to enable a receiving user 124 to access the message object 502, such that the receiving user 124 opens the message object 502;
wherein if the biometric authentication flag 550 is set to true, the receiving user 124 is required to perform a receiver biometric authentication (i.e. a biometric authentication of the receiving user 124) prior to accessing the message object 502, such that if the receiver biometric authentication fails, the message object 502 cannot be opened.

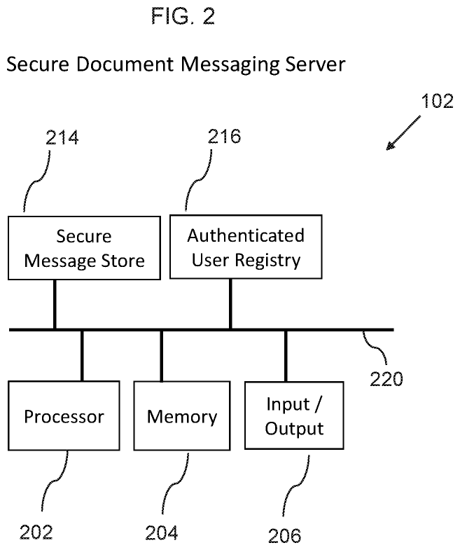

In another related embodiment, as shown in FIG. 2, the secure document messaging server can further include:
a) a processor 202;
b) a non-transitory memory 204;
c) an input/output component 206; and
f) an authenticated user registry 216, which comprises at least one biometrically authenticated user; all connected via
g) a data bus 320;
wherein the secure document messaging device 104 is configured to enable the sending user 122 to select the at least one recipient from the authenticated user registry, in communication via the secure document messaging server 102.

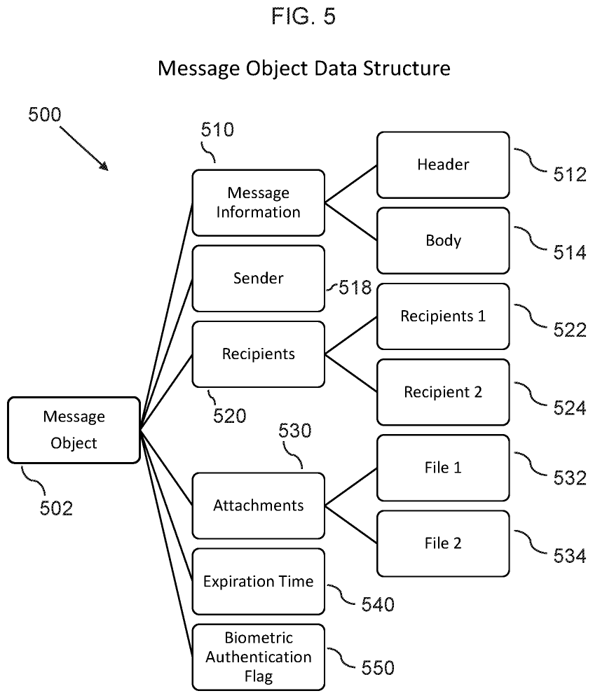

In a further related embodiment, as shown in FIG. 5, which shows a message object data structure 500, the message object 502 can further include:
at least one attachment file 530, 532.

In another further related embodiment, the message object 502 can further include:
an expiration time 540, which indicates when the message object 502 will expire.

In another further related embodiment, the message store 214 can be encrypted.

In related embodiments, the secure document messaging device 104 can be configured to perform a biometric authentication 309 by executing an authentication function 309 supported by the operating system 308 of the secure document messaging device 104. For example, on an IPHONE™, the IOS™ operating system 308, may depending on model, support a fingerprint-based biometric authentication 309, a face recognition based biometric authentication 309, an iris recognition based biometric authentication 309, a voice recognition based biometric authentication 309, or some other form of biometric authentication 309. In general, the operating system 308 can be configured to lock the device and make further user interaction impossible if a biometric authentication fails. In some alternative embodiments, wherein an operating system 308 of a secure document messaging device 104 does not support biometric authentication, the secure document messaging device 104 can be configured with a biometric authentication manager 312, which can be a custom developed software module that is configured/programmed to execute a biometric authentication algorithm, for example using an inbuilt camera of the secure document messaging device 104.

In a related embodiment, the secure document messaging device 104 can further include a lock dialogue 314 (which can also be called a lock screen 314, lock window 314, or lock module 314), which is configured to enable the sending user 122 to lock the message object 502, such that the sending user 122 is required to perform a sender biometric authentication 309 (i.e. a biometric authentication 309 of the sending user 122);

such that if the sender biometric authentication 309 succeeds, the biometric authentication flag 550 is set to true, such that the message object 502 is locked; and such that if the sender biometric authentication 309 fails, the biometric authentication flag 550 is set to false.

In another related embodiment, the secure document messaging system 100 can further include a biometric authentication server 114, which can be configured to perform back-end biometric authentication processing in communication with the operating system 308 of the secure document messaging device 104; such that a biometric authentication 309 of the operating system 308 of the secure document messaging device 104, communicates with the biometric authentication server 114 in order to process a biometric authentication of a user 122, 124. Such a biometric authentication server 114 is well-known in the art of biometric authentication, and is commonly provided as an inbuilt feature/service in mobile operating environments, such as APPLE IOS ICLOUD™, ORACLE™, etc. In some related embodiments, when biometric authentication is not provided by the underlying operating system 308, a custom developed biometric authentication manager 312 of the secure document messaging device 104 and a custom developed authentication server 114 may be provided as part of the secure document messaging system 100; or instead of a custom developed authentication server 114, the associated back-end authentication processing may be provided by the secure document messaging server 102.

In a related embodiment, the biometric authentication server 114 can be configured to provide biometric authentication and verification of users, and can include storage of security policies and physiological attributes such as facial image, iris, voice, and fingerprints. Additionally, the biometric authentication server 114 can provide workflow management, data management, transaction management, formatting, reporting, configuration management, fingerprint, face, voice, and iris analyzer along with other important utilities for authentication verification. As shown, the operating system 308 of the secure document messaging device 104 can be configured to communicate directly with the biometric authentication server 114, but in some embodiments the secure document messaging server 102 may invoke operating environment authentication functions in direct communication with the biometric authentication server 114.

In a related embodiment, the secure document messaging system 100 can further include an external document management system 112 which can provide document workflow and storage, and can store message object 502, including attachments 530, 532, and can also store individual documents and files, to be available to attach for message objects 502. In some example embodiments, the secure document messaging server 102 can integrate in a decoupled architecture with a financial service/bank document management system 112. In alternative embodiments, all or part of the secure document messaging server 102 can integrate as embedded plug-in components, to be available as a service in a financial service/bank document management system 112. Such external document management systems 112 are well-known in the art of document management, storage, and workflow; and can include simple cloud-based storage systems 112 and document workflow management systems 112, such as bank document workflow and messaging systems 112.

Thus, in a further related embodiment, the secure document messaging system 100 can further include an external document management system 112, which can be configured to provide document workflow and storage, such that the external document management system 112 can store the message object 502, in communication with the secure document messaging server 102.

In a related embodiment, the secure document messaging device 104 can be configured to enable a new user 122 to register as an authenticated user 122, such that the new user 122 is required to perform a biometric authentication 309 in order to register the new user 122, such that if (and only if) the biometric authentication succeeds, the new user 122 is added to the authenticated user registry 216 of authenticated users 122, of the secure document messaging server 102.

In a related embodiment, the secure document messaging device 104 can further include:
a biometric authentication manager 312, which is configured to execute a biometric authentication algorithm, such that the biometric authentication manager 312 processes the sender biometric authentication.

In another related embodiment, the secure document messaging device 104 can further include:
an operating system 308, which is configured to provide a biometric authentication component 309, such that the biometric authentication component 309 processes the sender biometric authentication 309.

In a related embodiment, the secure document messaging device 104 can be configured to enable a new user 122 to register as an authenticated user 122, such that the new user 122 is required to perform a new user biometric authentication 407 (i.e. a biometric authentication of the new user 122), such that if the new user biometric authentication 407 succeeds, the new user is added to the authenticated user registry 216.

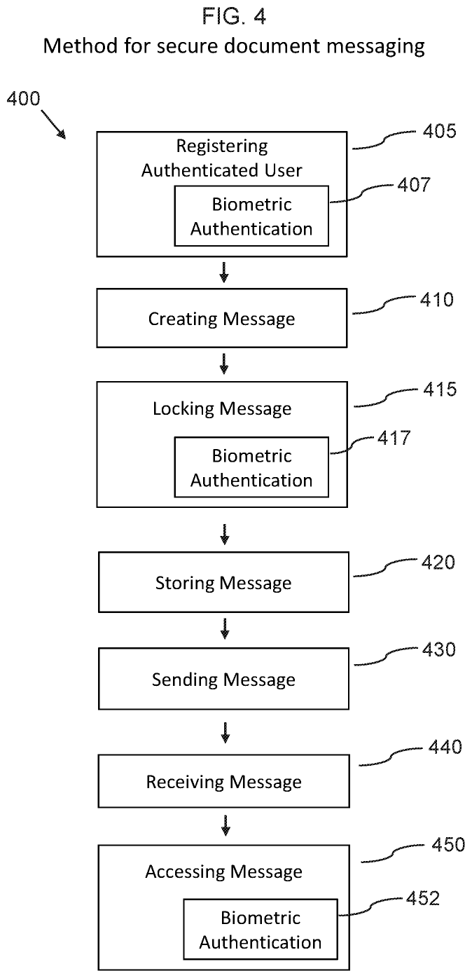

In an embodiment, as illustrated in FIG. 4, a method for secure document messaging 400, can include:
a) Creating a message 410, wherein a sending user 122 creates a message object 502, which can include
   i. message information 510, including a message heading text 512, and a message body text 514;
   ii. a sender 518, which is an identification of the sending user 122;
   iii. a list 520 of recipients 522, 524, or at least one recipient 522, which can be selected from an authenticated user registry 216, which is stored on the secure document messaging device 104;
   iv. a list/plurality 530 of attachment files 532, 534, or at least one attachment file 532, which can be selected from:
      1. a gallery/image library, which is stored on the secure document messaging device 104;
      2. An external device/storage (such as ICLOUD™), or external server;
      3. a live video recording taken by the secure document messaging device 104;
      4. a live photo taken by the secure document messaging device 104;
   v. An expiration time 540, which if filled out indicates when the message will expire (and be deleted or deactivated). The expiration time can be an absolute time stamp or a duration relative to a time of creation of the message;
   vi. A biometric authentication flag 550, which can be set to on or off (i.e. true/false, active/not active etc.);
   vii. A message status 560, which for example can be created, sent, received, expired, deleted (for logical delete), etc.
b) Locking the message 415, wherein the sending user 122 performs a sender biometric authentication 417;
such that if the sender biometric authentication 417 succeeds, the biometric authentication flag 550 is set to true, such that the message object is locked; and
such that if the sender biometric authentication 417 fails, the biometric authentication flag is set to false.
Note, that optionally the biometric authentication flag 550 can be set or defaulted to null/inactive, such that the message object 502 is not locked and the messaging functionality provided by the secure document messaging method 400 will for the particular message be similar to conventional messaging provided by conventional messaging systems, such as email, etc., such that no biometric authentication is required to send or receive the message object 502. In many usage scenarios a sending user 122 may elect to only lock some message objects 502, for example when they contain sensitive, confidential, or privileged information;
c) Storing the message 420, wherein the sending user 122 stores the message object 502 in a message store 214, which can be encrypted;
d) Sending the message 430, wherein the sending user 122 sends the message object to the recipients 520, if the biometric authentication flag 550 is set to true; and such that if the biometric authentication flag 550 is set to false, the message object 502 is not sent;
e) Receiving the message 440, wherein the receiving user 124 receives the message object 502 to the recipients 520, for example such that the message object 502 becomes visible in a list of received objects in an inbox for each of the receiving users 124 in the list of recipients 520. A received locked message object 502 may be shown with no identifying information (such as “new locked message”), or it may additionally identify the sender 518, and in some cases optionally the message header 512;
f) Accessing the message 450, wherein the receiving user 124 opens the message object 502; wherein if the biometric authentication flag 550 is set to true, the receiving user 124 is required to perform a receiver biometric authentication 452 prior to accessing the message object 502, such that if the receiver biometric authentication 452 fails, the message object 502 cannot be opened.

In a related embodiment, the method for secure document messaging 400 can further include registering a new user 405, wherein a new user 122 registers as an authenticated user 122, such that the new user 122 is required to perform a new user biometric authentication 407 (i.e. a biometric authentication of the new user 122), such that if the new user biometric authentication 407 succeeds, the new user 122 is added to an authenticated user registry 216 of authenticated users 122, 124.

In related embodiments, the secure document messaging device 104 can include configurations as:
a) A web application, executing in a web browser;
b) A tablet app, executing on a tablet device, such as for example an ANDROID™ or IOS™ tablet device;
c) A mobile app, executing on a mobile device, including a smartphone, such as for example an ANDROID™ phone or IPHONE™, or any wearable mobile device;
d) A desktop application, executing on a personal computer, or similar device;
e) An embedded application, executing on a processing device, such as for example a smart TV, a game console or other system.

It shall be understood that an executing instance of an embodiment of the secure document messaging system 100, as shown in FIG. 1, can include a plurality of secure document messaging devices 104, which are each tied to one or more users 122, 124. As shown in FIG. 1, a sending user 122 can use a sending secure document management device 104, to send a message 502 to a receiving user 124, who receives the message 502 on a receiving device 104. Thus, in general a user 122, 124 can act as a sending user 122, and a receiving user 124, using a secure document messaging device 104, and can send and receive messages to/from a plurality of users 122, 124, which are each using a corresponding personal secure document management device 104.

An executing instance of an embodiment of the secure document messaging system 100, as shown in FIG. 1, can similarly include a plurality of secure document messaging servers 102.

FIGS. 1, 2, 3, 4 and 5 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1, 2, and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIG. 1 shows a depiction of an embodiment of the secure document messaging system 100, including the secure document messaging server 102, and the secure document messaging device 104. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as AMAZON EC2™ or MICROSOFT AZURE™.

It shall be understood that the above-mentioned components of the secure document messaging server 102 and the secure document messaging device 104 are to be interpreted in the most general manner.

For example, the processors 202 302 can each respectively include a single physical microprocessor or microcontroller, a cluster of processors, a datacenter or a cluster of datacenters, a computing cloud service, and the like.

In a further example, the non-transitory memory 204 and the non-transitory memory 304 can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that the secure document messaging server 102 and the secure document messaging device 104 can each respectively include a number of other components that are well known in the art of general computer devices, and therefore shall not be further described herein. This can include system access to common functions and hardware, such as for example via operating system layers such as WINDOWS™, LINUX™, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the secure document messaging device 104 communicates with the secure document messaging server 102 over a network 106, which can include the general Internet, a Wide Area Network or a Local Area Network, or another form of communication network, transmitted on wired or wireless connections. Wireless networks can for example include Ethernet, Wi-Fi, BLUETOOTH™, ZIGBEE™, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the secure document messaging system 100, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the secure document messaging server 102 and the secure document messaging device 104. The components of the secure document messaging server 102 can be distributed over a plurality of physical, logical, or virtual servers. Parts or all of the components of the secure document messaging device 104 can be configured to operate in the secure document messaging server 102, whereby the secure document messaging device 104 for example can function as a thin client, performing only graphical user interface presentation and input/output functions. Alternatively, parts or all of the components of the secure document messaging server 102 can be configured to operate in the secure document messaging device 104. Also, in other alternative embodiments, functionality of the secure document messaging server 102 may be provided in the secure authentication server 114, or alternatively parts or all of functionality of the secure authentication server 114 may be provided in the secure document messaging server 102.

Many such alternative configurations are readily apparent, and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A secure document messaging system, comprising:
a) a secure document messaging server, which comprises:
a message store, which includes a plurality of message objects; and
b) a secure document messaging device, which comprises:
a lock dialogue;
wherein the secure document messaging device is configured to enable a sending user to create a message object, wherein the message object comprises:
message information;
at least one recipient; and
a biometric authentication flag;
wherein the lock dialogue of the secure document messaging device is configured to enable the sending user to lock the message object, such that the sending user is required to perform a sender biometric authentication;
such that if the sender biometric authentication succeeds, the biometric authentication flag is set to true, such that the message object is locked; and
such that if the sender biometric authentication fails, the biometric authentication flag is set to false;
such that the secure document messaging device stores the message object in the message store of the secure document messaging server;
wherein the secure document messaging device is configured to enable the sending user to send the message object to the at least one recipient, if the biometric authentication flag is set to true.

2. The secure document messaging system of claim 1, wherein the secure document messaging device further comprises:
a) a processor;
b) a non-transitory memory;
c) an input/output component; and
d) a messaging controller, which is configured to enable a receiving user to receive the message object;
wherein the messaging controller is configured to enable the receiving user to access the message object, such that the receiving user opens the message object;
wherein if the biometric authentication flag is set to true, the receiving user is required to perform a receiver biometric authentication prior to accessing the message object, such that if the receiver biometric authentication fails, the message object cannot be opened.

3. The secure document messaging system of claim 1, wherein the secure document messaging device further comprises:
a biometric authentication manager, which is configured to execute a biometric authentication algorithm, such that the biometric authentication manager processes the sender biometric authentication.

4. The secure document messaging system of claim 1, wherein the secure document messaging device further comprises:
an operating system, which is configured to provide a biometric authentication component, such that the biometric authentication component processes the sender biometric authentication.

5. The secure document messaging system of claim 1, wherein the secure document messaging server further comprises:
a) a processor;
b) a non-transitory memory;
c) an input/output component; and
d) an authenticated user registry, which comprises at least one biometrically authenticated user;
wherein the secure document messaging device is configured to enable the sending user to select the at least one recipient from the authenticated user registry, in communication via the secure document messaging server.

6. The secure document messaging system of claim 1, wherein the message object further comprises:
at least one attachment file.

7. The secure document messaging system of claim 1, wherein the message object further comprises:
an expiration time, which indicates when the message object will expire.

8. The secure document messaging system of claim 3, wherein the message store is encrypted.

9. The secure document messaging system of claim 5, wherein the secure document messaging device is configured to enable a new user to register as an authenticated user, such that the new user is required to perform a new user biometric authentication, such that if the new user biometric authentication succeeds, the new user is added to the authenticated user registry of the secure document messaging server.

10. The secure document messaging system of claim 1, further comprising:
a biometric authentication server, which is configured to perform back-end biometric authentication processing in communication with the secure document messaging device.

11. The secure document messaging system of claim 1, further comprising:
an external document management system, which is configured to provide document workflow and storage, such that the secure document messaging system stores the message object, in communication with the secure document messaging server.

12. A secure document messaging device, wherein the secure document messaging device is configured to enable a sending user to create a message object, wherein the message object comprises:
a) message information;
b) at least one recipient; and
c) a biometric authentication flag;
wherein the secure document messaging device is configured to enable the sending user to lock the message object, such that the sending user is required to perform a sender biometric authentication;
such that if the sender biometric authentication succeeds, the biometric authentication flag is set to true, such that the message object is locked; and
such that if the sender biometric authentication fails, the biometric authentication flag is set to false;
such that the secure document messaging device is configured to store the message object on a secure document messaging server;
wherein the secure document messaging device is configured to enable the sending user to send the message object to the at least one recipient, if the biometric authentication flag is set to true.

13. The secure document messaging device of claim 12, wherein the secure document messaging device further comprises:
a) a processor;
b) a non-transitory memory;
c) an input/output component; and
d) a messaging controller, which is configured to enable a receiving user to receive the message object;
wherein the messaging controller is configured to enable the receiving user to access the message object, such that the receiving user opens the message object;
wherein if the biometric authentication flag is set to true, the receiving user is required to perform a receiver biometric authentication prior to accessing the message object, such that if the receiver biometric authentication fails, the message object cannot be opened.

14. The secure document messaging device of claim 12, wherein the message object further comprises:
at least one attachment file.

15. The secure document messaging device of claim 12, wherein the message object further comprises:
an expiration time, which indicates when the message object will expire.

16. A method for secure document messaging, comprising:
a) creating a message, wherein a sending user creates a message object, wherein the message object comprises:
message information;
at least one recipient; and
a biometric authentication flag;
b) locking the message, wherein the sending user performs a sender biometric authentication;
such that if the sender biometric authentication succeeds, the biometric authentication flag is set to true, such that the message object is locked;
and such that if the sender biometric authentication fails, the biometric authentication flag is set to false;
c) storing the message, wherein the sending user stores the message object in a message store; and
d) sending the message, wherein the sending user sends the message object to the at least one recipient, if the biometric authentication flag is set to true, and such that if the biometric authentication flag is set to false, the message object is not sent.

17. The method for secure document messaging of claim 16, further comprising:
receiving the message, wherein a receiving user in the at least one recipient receives the message object.

18. The method for secure document messaging of claim 17, further comprising:
accessing the message, wherein the receiving user opens the message object, wherein if the biometric authentication flag is set to true, the receiving user is required to perform a receiver biometric authentication prior to accessing the message object, such that if the receiver biometric authentication fails, the message object cannot be opened.

19. The method for secure document messaging of claim 16, wherein creating the message further comprises:
selecting the at least one recipient from an authenticated user registry, which comprises at least one biometrically authenticated user.

20. The method for secure document messaging of claim 16, wherein the message object further comprises:
at least one attachment file.

21. The method for secure document messaging of claim 16, wherein the message object further comprises:
an expiration time, which indicates when the message object will expire.

22. The method for secure document messaging of claim 16, wherein a new user registers as an authenticated user, such that the new user is required to perform new user biometric authentication, such that if the new user biometric authentication succeeds, the new user is added to an authenticated user registry of authenticated users.
